(19) United States
(12) Patent Application Publication
(10) Pub. No.: US 2026/0017592 A1
(43) Pub. Date: Jan. 15, 2026

(54) ENTITY-SPECIFIC DATA ANALYSIS ENGINE IN A DATA INTELLIGENCE SYSTEM

(71) Applicant: Microsoft Technology Licensing, LLC, Redmond, WA (US)

(72) Inventors: Sahil Sanjay SANGHVI, Seattle, WA (US); Weisheng LI, Bothell, WA (US); Wesley Hsien-Yi CHAN, Sammamish, WA (US); Max PIASEVOLI, New York, NY (US); Srisuma MOVVA, Seattle, WA (US); Michael Abraham BETSER, Denver, CO (US); Homa HAYATYFAR, Seattle, WA (US); Melissa AILEM, Los Angeles, CA (US)

(21) Appl. No.: 18/769,171

(22) Filed: Jul. 10, 2024

(51) Int. Cl. G06Q 10/0635; G06Q 10/0637; G06Q 10/0639

(52) U.S. Cl. CPC G06Q 10/0635; G06Q 10/06375; G06Q 10/06393

(57) ABSTRACT

Methods, systems, and computer storage media for providing entity-specific data analysis using an entity-specific data analysis engine in a data intelligence system are described. The entity-specific data analysis engine can be an LM-based system that supports generating and communicating entity-specific data analysis output. In operation, a dataset associated with an entity is accessed. A bidirectional volumetric analysis output is generated based on executing a plurality of bidirectional volumetric analysis operations against the dataset. A plurality of probe questions and a plurality of data analysis axes associated with a focus area are generated for analyzing the bidirectional volumetric analysis output. Using the bidirectional volumetric analysis output, the plurality of probe questions, and the plurality of data analysis axes, an entity-specific data analysis output is generated, based in part on identifying false positive trends in the dataset and defining rules to filter out the false positives from the entity-specific data analysis output.

### BACKGROUND

Users rely on computing systems to analyze vast amounts of data, derive insights, and make informed decisions. A data intelligence system refers to sophisticated platform design to collect, process, analyze, and present data to help user make informed decisions. In particular, the data intelligence system may integrate various data sources, employ advanced analytics, and provide actionable insights through intuitive visualizations and report tools. For example, a data intelligence system can support visualizing trends, patterns, and anomalies. The data intelligence can enable real-time monitoring, predictive analytics and comprehensive reporting, enhancing strategic planning and operational efficiency across a wide range of domains from cybersecurity to healthcare.

### SUMMARY

Various aspects of the technology described herein are generally directed to systems, methods, and computer storage media for, among other things, providing entity-specific data analysis using an entity-specific data analysis engine in a data intelligence system. Entity-specific data analysis refers to a process of analyzing and interpreting data that is related to a particular entity (e.g., business, organization, individual, company, or other identifiable units) within a specific area of interest or focus. The entity-specific data analysis engine can be a (Language Model) LM-based system that performs entity-specific bidirectional volumetric analysis; few-shot prompting for domain-specific probing; iterative filtering and processing; and generating entity-specific data analysis output. The entity-specific data analysis engine can efficiently derive insights based on the unique characteristics, operations, and objectives of the entity in relation to the chosen focus area.

Conventionally, data intelligence systems are not configured with comprehensive logic and infrastructure to provide adequate and efficient entity-specific data analysis. Data intelligence systems operate based on vast amounts of datasets that include human-readable content that is both structured and semi-structured, making it too large for a machine learning models (e.g., large language models “LLMs”) to process the datasets in their entirety. It is necessary to summarize and categorize unstructured data into coherent clusters to enable comprehension and analysis of vast amounts of information. Processing large datasets without entity-specific-based techniques and assessment leads to several limitations: reduced accuracy, inability to handle complexity, data quality issues, scalability problems, inflexibility to new data, and poor optimization. These issues collectively hinder the effectiveness, accuracy, and scalability of data analysis. Processing large datasets in one go can be computationally intensive and may not scale well. A data analysis pipeline built on an integrated personalized entity data analysis platform enables entity-specific data analysis and classification to provide improved scalability and efficiency.

A technical solution—to the limitations of conventional data intelligence systems—can include providing entity-specific data analysis pipeline resources via an entity-specific data analysis engine. The entity-specific data analysis engine provides tailored data analysis for answering entity-specific questions. The entity-specific data analysis engine is an automated or semi-automated LM-based system that deeply analyzes communication patterns of an entity to create bespoke filters for data analysis and classification (e.g., risk detection). Using entity profile data and focus area data (e.g., entity information and domain-specific knowledge sources) associated with an investigation focus area, the entity-specific data analysis engine customizes data analysis to match an entity's unique signature.

The entity-specific data analysis engine supports performing entity-specific bidirectional volumetric analysis that detects relevant interactive entity communications, distinguishing it from non-interactive content. Few-shot prompting for domain-specific probing can include using few-shot prompts that transform domain knowledge about an entity into bespoke filters (i.e., probing questions and data analysis axes). Iterative filtering and processing are based on the filters including processing probing questions and data analysis axes to determine communications that are relevant and significant. Moreover, entity-specific data analysis engine ensures that relevant entity-specific data items are identified while filtering out noise. Few shot prompts are further utilized to generate an entity-specific data analysis output. In this way, the entity-specific data analysis engine provides personalized entity data analysis and classification with a strategic advantage by providing a customizable, efficient, and automated solution for managing specific types of data investigations.

In operation, in a first embodiment, a dataset associated with an entity is accessed. A bidirectional volumetric analysis output is generated based on executing a plurality of bidirectional volumetric analysis operations. A plurality of probe questions and a plurality of data analysis axes associated with a focus area are generated for analyzing the bidirectional volumetric analysis output. Using the bidirectional volumetric analysis output, the plurality of probe questions, and the plurality of data analysis axes, an entity-specific data analysis output is generated. The entity-specific data analysis output is communicated.

In a second embodiment, a dataset is accessed. A bidirectional volumetric analysis output is generated based on executing a plurality of bidirectional volumetric analysis operations. The bidirectional volumetric analysis output is communicated to cause generation of entity-specific data analysis output.

In a third embodiment, a focus area for investigating a dataset associated with an entity is accessed. A plurality of probe questions associated with the focus area are generated. A plurality of data analysis axes associated with the focus area are generated. A bidirectional volumetric analysis output is accessed. The bidirectional volumetric analysis output has been generated based on executing a plurality of bidirectional volumetric analysis operations on the dataset. Using the bidirectional volumetric analysis output, the plurality of probe questions, and the plurality of data analysis axes, an entity-specific data analysis output is generated for the entity. The entity-specific data analysis output for the entity is communicated.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIG. 1 is a block diagram of an exemplary data intelligence system including an entity-specific data analysis engine, in accordance with aspects of the technology described herein;

FIG. 2 is a block diagram associated with an exemplary data intelligence system including an entity-specific data analysis engine, in accordance with aspects of the technology described herein;

FIG. 3 provides a first exemplary method of providing entity-specific data analysis using an entity-specific data analysis engine, in accordance with aspects of the technology described herein;

FIG. 4 provides a second exemplary method of providing iterative data processing optimization using an entity-specific data analysis engine, in accordance with aspects of the technology described herein;

FIG. 5 provides a third exemplary method of providing entity-specific data analysis using an entity-specific data analysis engine, in accordance with aspects of the technology described herein;

FIG. 6 provides a block diagram of an exemplary data intelligence system suitable for use in implementing aspects of the technology described herein; and

FIG. 7 provides a block diagram of an exemplary distributed computing environment suitable for use in implementing aspects of the technology described herein; and

FIG. 8 is a block diagram of an exemplary computing environment suitable for use in implementing aspects of the technology described herein.

### DETAILED DESCRIPTION

### Overview

In a complex world of data management and data analysis, there exists a need for a personalized approach to data analysis. For example, in corporate risk management, a personalized approach to evaluating customer risk analysis is important. Organizations encounter unique challenges and require a system that can deliver tailored data analysis with a focus on answering entity-specific concerns. A data intelligence system provides a platform or framework designed to collect, process, analyze, and interpret large volumes of data from various sources to derive actionable insights and support decision-making processes. Data intelligence systems often utilize advanced technologies such as artificial intelligence, machine learning, natural language processing, and data visualization techniques to uncover patterns, trends, correlations, and anomalies within the data. By way of illustration, in cybersecurity, a data intelligence system monitors and analyzes network traffic, system logs, and other data sources to detect and respond to security threats. It uses advanced algorithms to identify suspicious activities, such as unauthorized access attempts or malware infections, and provides real-time alerts to security teams. By correlating data from multiple sources, it can uncover complex attack patterns and help organizations strengthen their defenses.

In a legal discovery context, a data intelligence system sifts through vast amounts of electronic documents, emails, and other digital records to find relevant information for legal proceedings. It employs machine learning and natural language processing techniques to identify key documents, extract important facts and relationships, and categorize information according to legal requirements. This helps legal teams streamline the discovery process, reduce costs, and ensure compliance with legal obligations. As such, a data intelligence system enables informed decision-making, provides a competitive edge, manages risks, enhances efficiency, improves customer experiences, reduces costs, ensures regulatory compliance, fosters innovation, and drives growth.

Conventionally, data intelligence systems are not configured with comprehensive logic and infrastructure to provide an adequate and efficient data analysis pipeline. Data intelligence systems process vast amounts of datasets that include human-readable content that is both structured and semi-structured, making it too large for machine learning models (e.g., large language models—LLM) to process the datasets in their entirety. In particular, data analysis for large amounts of data is done using fixed analysis and domain specific rules to analyze, triage, and summarize the data to understand the breadth and depth of relevant data and impact. Moreover, without effective data convergence functionality, current data intelligence systems are unable to harmonize disparate data sources or streams into a consistent and reconciled state for processing, which often results in discrepancies, errors, or incomplete information, hindering the data intelligence system's ability to provide accurate and reliable outputs. In addition, processing large datasets with fixed analysis frameworks, especially with LLMs or other machine learning models, leads to several limitations: reduced accuracy, inability to handle complexity, data quality issues, scalability problems, inflexibility to new data, increased risk of overfitting or underfitting, limited error correction, and poor optimization. These issues collectively hinder the effectiveness, accuracy, and scalability of data analysis. Processing large datasets in one go can be computationally exhaustive and not technically feasible.

Conventional data intelligence systems lack the capacity to fully integrate and contextualize the vast amounts of data necessary for a thorough relevant assessment, potentially leaving out critical documents. Current data intelligence systems, while indispensable for analyzing large datasets, face significant challenges in fully integrating and contextualizing the vast amounts of data necessary for comprehensive assessments. Integration poses a major hurdle as these systems have to reconcile diverse data formats and sources, often resulting in gaps or inconsistencies in the analysis. Moreover, contextualization, which is vital for accurate insights, remains a challenge as existing data intelligence systems struggle to grasp nuanced contexts such as the relationships between data points or the historical patterns underlying them. With the exponential growth of data, these data intelligence systems also grapple with processing and analyzing massive volumes of information efficiently and effectively. Consequently, despite their capabilities, they may fail to provide thorough assessments. In the case of risk assessment for vulnerable emails within a corpus, this deficiency could mean overlooking crucial indicators of security threats, potentially exposing organizations to cyberattacks or other security breaches. As such, a more comprehensive data intelligence system—with an alternative basis for performing data intelligence operations—can improve computing operations and interfaces in data intelligence systems.

### DESCRIPTION OF TECHNICAL SOLUTION

At a high level, an entity-specific data analysis engine employs language models (e.g., foundation models, large language models (LLMs), small language models (SLMs), mixture of expert models (MoE), or multi-modal model) to provide a personalized (i.e., entity-specific) approach to data analysis. An entity can refer to an identifiable and distinct unit within a given context, which can be an object, person, organization, or company that possesses a unique set of characteristics or attributes. For example, entities can be two separate companies or can be departments within the company. Entities have distinct profiles and concerns shaped by their industry, operational scale, and internal practices. For example, a company may have a distinct risk profile that is shaped by entity profile data because the entity profile data provides detailed insights into the unique characteristics, behaviors, and vulnerabilities of the entity, allowing for a more accurate and tailored risk assessment. By considering these individualized factors, risk evaluation can identify specific threats and mitigation strategies that are most relevant to the entity's particular context.

Data analysis that is not entity-specific is inherently limited because it fails to account for the unique characteristics, contexts, and needs of the particular entity under investigation. This limitation becomes particularly pronounced in the realm of risk analysis for datasets associated with breaches. Without personalization, the analysis may overlook critical nuances such as the specific types of data the entity handles, the distinct threat landscape it faces, and its particular regulatory obligations. For instance, a generic analysis might not adequately highlight the severe repercussions for a healthcare organization if patient records are compromised, compared to a similar breach in a different industry. Moreover, the analysis might ignore the entity's unique data protection protocols, user access patterns, and historical vulnerabilities, which are essential for crafting precise risk assessment and mitigation strategies. Consequently, the absence of an entity-specific approach can result in incomplete or misguided recommendations, ultimately compromising the effectiveness of the risk management efforts.

Entity-specific data analysis (e.g., personalized risk analysis) enables accurate identification and management of data analysis insights, ensuring that appropriate actions are taken based on the data analysis insights. For example, personalized risk analysis ensures mitigation strategies are both effective and efficient. An entity-specific data analysis approach leverages LMs to overcome expertise bottlenecks often encountered in the management and updating of rules, filters, and report writing for each company—a process that is typically time-consuming and expensive. Entity-specific data analysis can be performed for a focus area of an investigation. The focus area refers to a specific aspect or domain of interest that guides a data analysis. It determines the scope and objectives of the investigation, ensuring that the analysis is targeted and relevant to the goals of the inquiry. By way of illustration, a focus area for email risk analysis could be phishing detection and prevention. This involves analyzing email datasets to identify patterns and indicators of phishing attempts, such as suspicious sender addresses, unusual attachment types, or links to known malicious domains, with the goal of enhancing email security measures and protecting users from potential threats. In this way, a focus area can also include an aspect investigators concentrate on to gather evidence, analyze data, or draw conclusions.

The entity-specific data analysis engine is based on an advanced framework designed to analyze an entity's data and communication patterns deeply to create bespoke filters (e.g., probe questions and data analysis axes) for data analysis. For example, bespoke filters may support risk detection in data associated with a company. Using tenant information from internal profiles, as well as domain-specific knowledge sources (e.g., Common Vulnerabilities and Exposure (CVE) database, MITRE, internal definitions) and investigation focus area, the entity-specific data analysis engine customizes it analysis to match the entity's unique signature. For example, the entity-specific data analysis engine can identify high-risk communication within a company and establish filters to scrutinize sensitive interactions involving third-parties, departments, or confidential information.

Through this process, the entity-specific data analysis engine refines its filters based on the data it processes. The entity-specific data analysis engine uses few-shot prompts to generate probing questions tailored to a tenant's domain, leveraging both internal domain knowledge about the company (e.g., databases, rules, profiles)—as well as external information (e.g., CVE, MITRE). This enables the entity-specific data analysis to make informed decisions on adjusting the filtering criteria and updating the entity-specific data analysis engine—allowing it to adapt to each entity in a distinctive manner.

### Example Systems and Resources

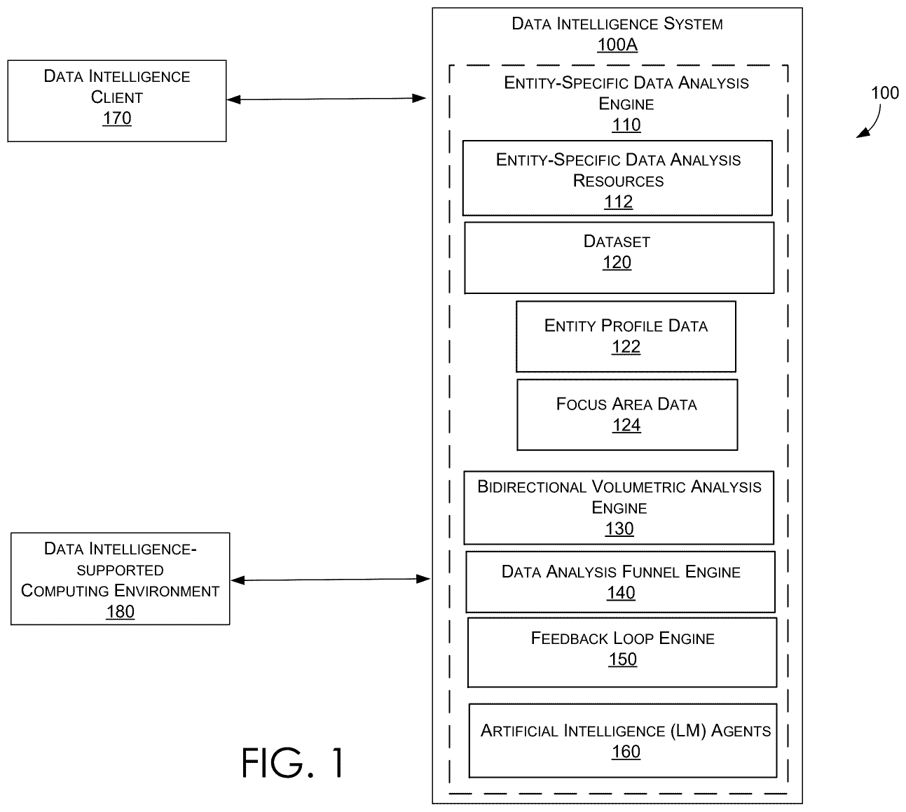

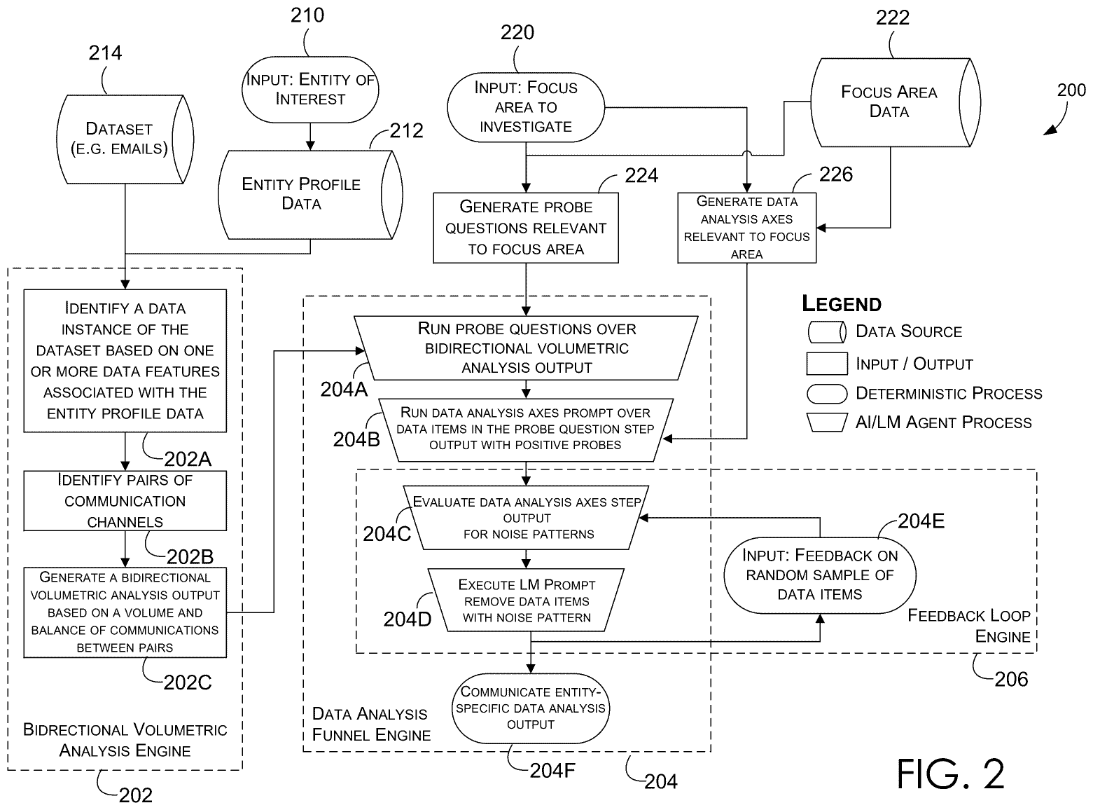

Aspects of the technical solution can be described by way of examples and with reference to FIGS. 1 and 2. FIG. 1 illustrates a cloud computing environment (system) 100, data intelligence system 100A, entity-specific data analysis engine 110, entity-specific data analysis resources 112, dataset 120, entity profile data 122, focus area data 124, bidirectional volumetric analysis engine 130, data analysis funnel engine 140, feedback loop engine 150, and artificial intelligence and LM agents 160; data intelligence client 170 and data intelligence-supported computing environment 180.

Cloud computing system 100 includes data intelligence system 100A that provides an operating environment for entity-specific data analysis engine 100 that operates with data intelligence client 170 and data intelligence-supported computing environment 180. The entity-specific data analysis engine 110 operates in conjunction with a data intelligence client 170, facilitating the provisioning of entity-specific data analysis engine 110 functionality that can be tailored for data intelligence-supported computing environment 180. For example, through user interactions via the data intelligence client 170, the data intelligence client 170 leverages the entity-specific data analysis engine 110 to generate explainable analysis of large volumes of data (e.g., dataset 120) associated with data intelligence-supported computing environment 180.

Entity-specific data analysis resources 112 include operations, interfaces, and data that support providing data analysis functionality. The operations include bidirectional volumetric analysis to identify relevant data items in a dataset or data instance, data analysis funneling to incrementally and iteratively reduce and analyze a dataset associated with a particular investigation focus area; and a feedback loop associated with noise reduction and feedback on data items. Interfaces involve graphical user interfaces (GUIs) for user-friendly interaction, visualizations for pattern and trend analysis, command-line interfaces (CLIs) for automation and advanced features, APIs for integrating with other systems, and web services for remote access. The data includes raw datasets, intermediate processed data, analysis results, clustered-data outputs, and final insights for reporting and decision-making. Entity-specific data analysis resources 112 enable a structured approach that ensures efficient data processing and continuous optimization, facilitating informed decision-making and effective entity-specific data analysis.

By way of illustration, entity-specific data analysis engine 110 supports investigating a dataset (e.g. dataset 120) to find data items matching certain criteria (e.g., focus area). In particular, the dataset can be a massive dataset with structured and unstructured data in a particular domain. For example, the dataset 120 can be emails or documents from breach data. The dataset 120 can be associated criteria is defined for searching the dataset 120 for specific information (e.g., content in data items). Conventionally a keyword-based search engine may be employed to identify relevant data items; however, these conventional systems are limited in that their functionality merely performs literal comparison of text in contrast to semantic analysis associated with entity-specific data analysis engine 110.

The entity-specific data analysis engine 110 provides an automated and/or semi-automated entity-specific data analysis approach using bidirectional volumetric analysis and data classification that categorizes data based on its content, context, or metadata, identifying and labeling data items according to predefined criteria. The entity-specific data analysis engine 110 can provide multi-view iterative processing where data is examined through multiple views, each offering different levels of detail and corresponding computational costs. The entity-specific data analysis 110 includes a standardized and automated architecture that supports repeatability and customization with each execution iteration for investigative data processing and analysis. Moreover, for unstructured data, the entity-specific data analysis engine 110 operates to reduce large volumes of data into a manageable dataset with structure and ranking relative to a particular investigative analysis.

Entity-specific data analysis engine 110 employs artificial intelligence (AI) and language model agents and corresponding techniques and algorithms to support functionality described herein. For example, entity-specific data analysis engine 110 employs few-shot prompting, where few-shot prompting is a technique used in natural language processing (NLP) where a language model is given a limited number of examples (or “shots”) to illustrate a specific task or type of response before generating its own output. This approach allows the model to understand the task at hand and produce relevant responses or perform tasks effectively, even with minimal examples. Few-shot prompting is particularly useful for scenarios where large annotated datasets are unavailable, enabling the model to adapt and respond based on the limited provided context.

The dataset 120 can include a collection of data (i.e., data items, data points, records). The dataset 120 can include structured or unstructured data associated with different domains. The dataset 120 can be associated with a particular entity and includes communications between the entity and one or more second entities. The dataset 120 (e.g., breached data, emails, discovery documents, social media communications) is associated with data analysis (i.e., investigation, classification). The data analysis can be for risk analysis of data items (e.g., emails in cybersecurity) or relevance of data items (e.g., documents in legal discovery). The dataset 120, by way of example, can include breached data (e.g., emails) associated with data breach.

An entity can refer to an identifiable and distinct unit within a given context, which can be an object, person, organization, or company that possesses a unique set of characteristics or attributes. For example, entities can be two separate companies or can be departments within the company. An entity can be associated with entity profile data (e.g., entity profile data 122) that refers to comprehensive set of data attributes and details that describe a specific entity, providing a holistic view of its characteristics, behavior, and relationships within a given context. This profile encompasses various data points such as unique identifiers, descriptive attributes, historical records, and relevant metadata, facilitating in-depth analysis and decision-making. For example, an entity profile data for a cloud customer can include sales information, customer profile, tenancy and web domain data.

The entity can be associated with a focus area of a data analysis of the dataset 120. The focus area refers to a specific aspect or domain of interest that guides a data analysis. It determines the scope and objectives of the investigation, ensuring that the analysis is targeted and relevant to the goals of the inquiry. A focus area for email risk analysis could be phishing detection and prevention. This involves analyzing email datasets to identify patterns and indicators of phishing attempts, such as suspicious sender addresses, unusual attachment types, or links to known malicious domains, with the goal of enhancing email security measures and protecting users from potential threats.

A data feature associated with a dataset refers to a specific characteristic or attribute of the data that is used to facilitate data analysis. These data features are aspects of the dataset that contain valuable information relevant to the analysis objectives. Examples of data features include numerical values, categorical variables, text fields, dates, and other descriptors that provide insights and patterns when analyzed using statistical, machine learning, or other analytical techniques. These data features serve as the building blocks for identifying data items in the scope of analysis and extracting meaningful information and deriving actionable insights from the dataset.

A data feature (i.e., a portion of a sender-recipient pair identifier) can be associated with determining two-way communications between an entity and a second entity. A sender-recipient pair identifier is a unique identifier that is associated with both the sender and the recipient in a communication exchange. It ensures that both parties can correctly identify each other and establish two-way communication. Examples of sender-recipient pair identifiers include:
Email address—in email communication, the sender's email address and the recipient's email address together form the sender-recipient pair identifier. For example, sender@example.com sending an email to recipient@example.org;
Phone numbers—telecommunications, a phone number serves as the sender-recipient pair identifier for voice calls and text messages. For instance, +123456789 calling or texting +987654321;
Usernames in messaging apps: messaging applications often use usernames to identify users. The combination of the sender's username and the recipient's username forms the sender-recipient pair identifier. For example, sender123 messaging recipient456 in a messaging app; and
IP addresses—network communication, IP addresses uniquely identify devices. The sender's IP address and the recipient's IP address can be used to establish a sender-recipient pair identifier for data transmission.

The sender portion of the sender-recipient pair identifier uniquely identifies the entity that initiates and sends the communication. It typically includes information that specifies the originator of the message or data being transmitted. The receiver portion of the sender-recipient pair identifier uniquely identifies the entity that is intended to receive and process the communication. It specifies the destination or recipient of the message or data. A data feature can be associated with a sender portion, a receiver portion, or both. The data feature is associated with analyzing pairs of senders and recipients within a dataset, such as email addresses, phone numbers, or user IDs, to determine mutual interactions or exchanges between parties. The data feature can be associated with the type of investigation that is being performed. An example data feature can be an internet domain name associated with the sender's email address. The data feature can also be associated with the entity profile data 122 of the entity.

Data features associated with the entity can be identified for an initial filtering step (e.g., an initial filtering operation) of the dataset into a data instance for additional analysis. Data items that include the data features are be selected provided in a data instance of the dataset 120 for additional analysis. For example, emails having a particular email domain can be identified and filtered into the data instance. By extracting and examining the domains from which these emails originate, the data items in the data instance can be further ranked and filtered. Analyzing sender-recipient pairs allows for understanding interactions and filtering a data instance (i.e., subset of dataset) or dataset based on bidirectional volumetric analysis.

The bidirectional volumetric analysis engine 130—via bidirectional volumetric analysis operations—supports providing a heuristic for identifying relevant communications to a focus area of a data analysis. Bidirectional volumetric analysis operations enable selecting data items associated with communications involving back-and-forth interactions between sender-recipient pairs, while simultaneously excluding data items associated with one-way communications that lack reciprocal exchanges between sender-recipient pairs. The heuristic can support identifying relevant communications without looking at the content of the data items. Bidirectional volumetric analysis can include evaluating the volume and balance of communications in a communication channel. The communication channel can be person-to-person, team-to-team, group-to-group. Moreover, sender-recipient pairs do not necessarily need to be symmetrical in terms of the size or type of entities involved. While traditional sender-recipient pairs often involve one person sending information to another person, they can also encompass scenarios where a person communicates with a group or team. This broader definition encompasses any type of sender-recipient exchange, allowing for flexibility in understanding how communication occurs across various contexts and scales. The communications for a communication channel can be aggregated and analyzed.

By way of illustration, bidirectional volumetric analysis (i.e., via bidirectional volumetric analysis operations) can begin with a pre-processing step (e.g., a pre-processing operation) that includes identifying sender-recipient pairs, grouping communications based on unique combinations of senders and recipients within the data instance. This process ensures that each distinct interaction is properly categorized. Additionally, the bidirectional volumetric analysis can include a filtering out step (i.e., a filtering out operation) that filters communications that lack reciprocation, such as one-way emails where no reply is recorded. This directionality filtering ensures that only bidirectional communications are considered for further analysis.

Following the pre-processing step and the filtering out step, the bidirectional volumetric analysis moves to metrics calculation step (e.g., metric calculation operation). It quantifies the volume of communications exchanged between each sender-recipient pair. This metric counts the number email exchanges. It is further contemplated that other messages or interactions, including messages, calls, or other forms of communication may be counted. Furthermore, the bidirectional volumetric analysis calculates the balance of communications for each pair. This involves comparing the number of emails sent by the sender to the recipient against messages sent in the opposite direction. By computing a simple ratio or difference, the bidirectional volumetric analysis assesses whether communication between a pair is balanced or skewed towards one party. These initial bidirectional volumetric analysis steps lay the foundation for subsequent ranking and analysis, enabling the entity-specific data analysis engine to identify and prioritize sender-recipient pairs based on both the quantity and balance of their communications.

In the ranking step (e.g., a ranking operation), the bidirectional volumetric analysis may rank the data items in the data instance based on volume metrics and/or balance metrics. In one embodiment, ranking can include applying a weighted approach to prioritize sender-recipient pairs. The bidirectional volumetric analysis assigns weights to metrics such as communication volume and balance, reflecting their relative significance. Once weights are assigned, the bidirectional volumetric analysis computes a ranking score for each sender-recipient pair by combining these weighted metrics. This score synthesizes factors like the total number of emails exchanged and the proportion of reciprocal interactions. For example, pairs demonstrating high volume along with balanced communication patterns can achieve higher rankings, indicating strong and mutually beneficial relationships. This ranking mechanism ensures that the most meaningful sender-recipient connections are identified and highlighted based on comprehensive analysis of their communication dynamics. The ranked data items can be provided as bidirectional volumetric analysis output. The bidirectional volumetric analysis output may also be a subset of the ranked data items, where the subset is selected based on their corresponding data item ranks. As such, data items (e.g., emails) associated with communications between an entity and a second entity can be filtered and selected based on a volume and/or balance (e.g., communication equity ratio) of communications between the entity and a second entity (e.g., person-to-person emails). Other variations and combination of ranking, weighting, and selecting data items are contemplated with embodiment described herein.

As such, the plurality of bidirectional volumetric analysis operations include each of the following: an initial filtering operation associated with identifying a data instance; a pre-processing operation associated with identifying sender-recipient pairs that define corresponding communication channels; a metrics calculation operation associated with quantifying a volume of communications and a balance of communications between sender-recipient pairs; and a ranking operation associated employing volume metrics or balance metrics to rank data items associated with sender-recipient pairs.

A data analysis funnel engine 140—via data analysis funnel operations—provides additional functionality associated with the entity-specific data analysis pipeline. The data analysis funnel engine 140 operates based on two artifacts: probe questions and data analysis axes. A probe question, in the context data analysis funnel engine 140 and a language model (LM), is a specific type of question designed to elicit a response that indicates the presence or absence of certain types of information in data items. For example, an LLM can make a determination whether sensitive information such as passwords, keys, or credentials are present or absent in a data item. Typically, these questions are structured to require a yes or no answer or a specific type of data response.

A probe question refers to a specific query or inquiry designed to extract targeted information or insights from a dataset. These probe questions are formulated based on the content and structure of the data items within the dataset. Probe questions typically aim to uncover patterns, relationships, anomalies, or trends in the data. They serve as focused prompts that guide the exploration and analysis of data to achieve specific objectives or to answer particular research questions.

Probe questions can be in different type of question formats (e.g., simple yes/no questions, or discrete yes/no/maybe) that will be answer—using a language model—based on the content of data items in a dataset. For example, for email data items in an email data, probe questions for cybersecurity enforcement can include: “Does this email discuss a vulnerability related to a storage data?” or “Does this email discuss an (multi-factor authentication) MFA bypass or similar identity vulnerability?” Both probes check for risky email content but in different forms. In this way, the probe questions can be in different forms but check for the same category of information.

Probe questions serve as a focused inquiry directed at a language model to identify the content and context of a specific data item aligned with an investigation's focus area. For example, a first probe question can be: “Does the email contain any suspicious links or attachments?” This question targets the presence of potentially risky elements like phishing links or malicious attachments within the email content. A second question can be: “Does the email exhibit unusual metadata such as abnormal timestamps or inconsistent routing information?” This question targets anomalies in the metadata of the email, which can indicate potential spoofing or manipulation attempts. These probe questions are structured to gather specific information related to the riskiness of an email based on elements such as content analysis and metadata examination.

The plurality of data analysis axes represents multifaceted factors against which the LM evaluates the presence and relevance of diverse types of pertinent data within the examined data item. Evaluating the relevance of a data item to a specific investigation focus area, a data analysis axis refers to a factor or dimension that contributes to the assessment or scoring of that data item. These data analysis axes serve as criteria against which the data item is evaluated, providing structured reasoning for the score assigned to each axis. For example, each axis can represent a distinct factor or parameter relevant to assessing the risk level associated with an email. These data analysis axes could include factors such as: content analysis to assesses the content of the email for suspicious keywords, attachments, or URLs; metadata examination that considers metadata such as timestamps, routing information, and email headers; and contextual factors that takes into account the context in which the email was received or its relationship to other emails or events.

Operationally, the data analysis funnel engine 140 accesses a focus area (e.g., a focus area identifier) and accesses focus area data. Focus area data, in this context, can refer to public or private domain-specific information associated with an investigation. This focus area data is specifically selected based on its relevance and applicability to the investigation's objectives, ensuring that the analysis targets and examines the most pertinent information related to the identified focus area. For example, domain-specific data can refer to information that is specific and relevant to a particular field or industry, characterized by its applicability within that domain and often including specialized terminology and practices. Internal security policy data can include a set of guidelines, rules, and procedures established within an organization to ensure the security and protection of its assets and sensitive information. It includes data classification (such as confidential and highly confidential levels) and outlines security measures to safeguard information from unauthorized access or disclosure.

Focus area data (e.g., domain-specific data and internal security policy data) enable accurate and meaningful data analysis within for specific entity because they context and relevance that aligns with the entity's industry and operations, ensuring insights drawn are applicable and actionable. Together, probe questions and data analysis axes form integral components of investigative methodologies, guiding their corresponding AI or LM agents in extracting actionable insights and facilitating a structured approach to understanding complex datasets.

The data analysis funnel engine 140 generates probing questions that are relevant to the focus area. The probe questions can be curated manually and/or automatically. For example, an LM can generate and adjust probe questions. The can formulate questions based on predefined criteria or patterns identified in the data, such as specific keywords, formats, or categories. By leveraging its understanding of language and context, the LM can dynamically adjust the questions to account for variations in data representation and ensure comprehensive coverage of the desired information types. This adjustment involves modifying the wording of existing questions to better fit the nuances of the data or adding entirely new questions based on the responses it generates from sample outputs. By way of illustration, the adjustment of the probe questions ensures that they effectively filter out noise, such as managing a high volume of emails where “yes” responses might be overly frequent due to innocuous reasons like internal newsletters or automated notifications. Simultaneously, this adjustment enables balancing the recall of potentially relevant data items, ensuring that emails containing genuinely risky content, such as phishing attempts with malicious links or attachments, are not mistakenly labeled as “no.” This way, the system optimally detects and prioritizes genuine threats while minimizing false alarms. This capability allows refining an understanding and exploration of the dataset, potentially uncovering deeper insights or refining its analysis based on the evolving context or requirements of the task at hand.

The data analysis funnel engine 140 generates data analysis axes. The plurality of data analysis axes in the context of evaluating data items allows the LM to comprehensively assess the presence and relevance of various types of pertinent data. Each data analysis axis represents a specific factor or dimension contributing to the evaluation of a data item's relevance to a particular investigation focus area. These data analysis axes serve as criteria for scoring the data item, with structured reasoning provided for each score based on factors like content analysis, metadata examination, and contextual considerations. This systematic approach can facilitate a thorough data analysis (e.g., evaluation of the riskiness or relevance of emails, aiding in decision-making and further investigative steps by synthesizing information across multiple dimensions).

The data analysis funnel engine 140—via a probing step LM—accesses bidirectional volumetric analysis output and executes the probe questions on the bidirectional volumetric analysis output to generate a probing step output. The probing step out can include data items with positive probe responses. In the process of evaluating data items, the process involves running each data item through probing questions designed to efficiently gather specific information. The process is focused on discrete responses, ensuring computational efficiency by addressing straightforward criteria such as the presence of sensitive data or specific keywords. By aggregating the results of these probing questions, the data analysis funnel engine 140 can provide insights and actionable information, supporting decision-making processes effectively.

The data analysis funnel engine 140—via a data analysis axes step LM—accesses the probing step output and executes data analysis axes prompts over the data items in the probing step output. The data analysis funnel engine 140 generates data analysis axes step output. The data analysis axes output can be associated with scoring and reasoning. For each data analysis axis, the LM can provides a score (e.g., low, medium, high) that indicates the level of relevance or risk based on the factor's evaluation; and a reasoning for the score that provides an explanation or justification for why the score was assigned, referencing specific aspects of the data item that influenced the assessment.

In a cybersecurity context, these data analysis axes collectively contribute to the overall evaluation of an email's riskiness or relevance to the investigation focus area. The data analysis funnel engine 140 can be used to perform risk analysis of emails across multiple data analysis axes of evaluation. These data analysis axes encompass various facets such as sensitive information, threats and harassment, legal compliance, fraud indicators, and malware/security risks. For each data item, the data analysis axes step LM initiates the data analysis axes evaluation to classify its risk severity level, ranging from low to critical. The data analysis axes step LM can further provide explanations for its risk assessments, grounded in specific references to the content of the email. For example, if an email includes user credentials, the data analysis axes step LM identifies the presence of such data and cites the exact segments within the email where this information resides.

The data analysis axes step LM synthesizes information from each axis to provide a comprehensive assessment, which aids in decision-making or further investigation steps. By defining and using multiple data analysis axes, the data analysis axes step LM can systematically analyze and reason about data items, facilitating more informed judgments or actions based on the specific investigative needs or objectives at hand. The data analysis funnel engine 140 can also track responses to probe questions associated with data items. By tracking these probe responses, the data analysis funnel engine 140 provides valuable insights into the effectiveness of probe questions and highlights areas where improvements or adjustments may be necessary to enhance probe questions.

The data analysis funnel engine 140 may access—via an extraction step LM—data analysis axes step output. The extraction step LM extractor is designed to identify specific context or information from data items in data analysis axes step output. A predefined set of instructions or queries can be given to the extraction step LM to extract relevant information, such as dates, names, or specific patterns from text or data. The extraction step LM supports identifying instances noise including false positives in data items. Noise can refer to irrelevant or unwanted data that does not fit the context or purpose of the extraction. False positives can refer to instances where the extraction step LM incorrectly identifies information as matching the prompt, but it is not relevant or accurate. After the extraction step LM analyzes the results to identify patterns of noise. The extraction step LM is then updated to include filters or rules that help the extraction step LM recognize and ignore such false positives and noise in future extractions.

The data analysis funnel engine 140 may access—a removal step LM—to remove data items in the data analysis axes step output with noise patterns. The removal step LM can operate to execute a prompt to remove data items identified as containing noise-or false positives. A set of instructions or queries given to the removal step LM enable identifying and removing data items that do not meet the refined criteria after the first extraction. For example, email that include passwords for videoconference systems may not necessarily indicate a risky email. The email content may include typical meeting logistics such as the date, time, video conference link, and a password (e.g., “123456”). Data analysis funnel engine 140 flags any emails containing numeric sequences as potentially risky, assuming they might be passwords. However, upon closer inspection and learning from such cases, the data analysis funnel engine 140 refines its approach and updates its extraction rules to distinguish between harmless internal communications (like sharing meeting details) and genuinely risky emails. In this way, the data analysis funnel engine 140 has the ability to learn and adapt from patterns of noise and false positives so it can effectively filter out irrelevant information, such as passwords used for routine, non-threatening purposes like videoconference scheduling.

The data analysis funnel engine 140 communicates the remaining data items—after the removal step—as entity-specific data items (i.e., entity-specific data analysis output) that are data items that meet investigation criteria for a focus area. In this way, entity-specific data analysis output refers to the detailed results obtained from analyzing data that pertains specifically to a defined entity. This type of analysis focuses on extracting meaningful insights and patterns that are directly relevant within the unique context of that entity. When conducting entity-specific data analysis, the emphasis lies on understanding the specific attributes, operations, and challenges associated with the entity under study. This tailored approach ensures that the analysis techniques and methodologies used are customized to suit the entity's data requirements and objectives.

The output of such analysis aims to provide actionable insights and recommendations that can drive informed decision-making and strategic initiatives within the entity. Whether it involves assessing performance metrics for a particular product line within a company, evaluating risk factors specific to a customer or financial institution, or optimizing operational efficiency within a manufacturing facility, entity-specific data analysis output enables translating raw data into valuable information that supports organizational goals and objectives.

Additionally, the data analysis funnel engine 140 may provide supplemental data for data items, where the supplemental data is associated with the entity-specific data analysis process. For example, the data analysis funnel engine 140 processes emails that meet specific investigation criteria related to cybersecurity risks, such as emails containing mentions of credentials. For each identified email, the data analysis funnel engine 140 can provide a reasoning attribute and a content attribute, where the reasoning attribute that indicates why the email meets predefined criteria for being considered potentially risky (e.g., the email includes a credential), and the content attribute specifically identifies the credentials (e.g., usernames, passwords, API keys, or other forms of sensitive authentication information). The data analysis funnel engine 140 identifies the actual value associated with the credential. The data analysis funnel engine 140 identifies the relevant portion of the email where the credential and its associated value are mentioned.

A feedback loop engine 150—that includes extraction step LM, removal step LM, and feedback on a set of data items can be provided. The set of data items (e.g., samples) can be selected using a variety of techniques. For example, the feedback loop engine 150 can employ clustering methods to group data items (such as emails) before feeding them into the feedback loop engine to improve the feedback loop engine's capacity to identify false positive trends. Another approach can include integrating an LLM-based solution to bin or categorize data items into samples prior to their input into the feedback loop engine. The feedback loop engine is associated with iteratively executing an extraction step LM and a removal step LM based on feedback on a sample of data items. Initially, the extraction step LM analyzes the dataset to identify noise and false positives. It is further contemplated that the extraction step LM can identify both true positives and false positives, which is beneficial for the filtering step. The removal step LM can then utilize this capability to develop a filtering mechanism that effectively removes false positives (FPs) while retaining true positives.

The removal step LM then filters out irrelevant or unwanted data items based on predefined noise and false positive (or true positives) identified during extraction. Feedback on samples of data items allows for validation and adjustment of the extraction and removal processes, ensuring accuracy and efficiency in subsequent iterations. This iterative approach enhances the precision of data processing by continuously refining the LM models' performance based on real-world (manual or automated) data feedback.

It is contemplated that data analysis funnel engine 140 facilitates iterative data analysis with clustering capabilities at each step, aiming to identify and backtrack relevant data items through progressive clusters. The data analysis funnel engine 140 may employ clustering techniques for the outputs—for example, outputs at each step—to optimize the review process and facilitate efficient management of identified risks. By clustering similar data items (e.g., emails) based on shared analysis profiles or thematic content, the data analysis funnel engine 140 enables expedited review workflows. Annotations associated with these clusters provide additional context and insights, aiding reviewers in prioritizing their efforts and addressing high-priority risks promptly and effectively.

At each step of the data analysis funnel engine 140, data items are processed and clustered based on corresponding parameters or preliminary insights of the corresponding step, generating clusters that represent distinct groups of data items with similar characteristics or patterns. As the analysis progresses, each subsequent step refines these clusters, executing corresponding LMs to further segment and identify nuanced relationships within the data. Moreover, metadata is generated at each step documenting the data analysis. Each step generates metadata describing intermediate results, such as summary statistics, feature selection criteria, or model evaluation metrics. This metadata is structured to capture the rationale behind decisions made during the analysis, ensuring transparency and reproducibility. At the final output step, comprehensive clusters encapsulate refined data items deemed relevant based via the data analysis funnel engine 140. Each cluster represents a cohesive group of data items sharing common attributes or relationships, with metadata providing insights into the rationale behind their inclusion.

Data analysis funnel engine 140 supports backtracking from identified relevant data items by tracing their origins through progressive backwards clusters. This iterative approach allows stakeholders to explore related data items that might have been overlooked initially but are potentially relevant based on similar clustering patterns or shared features. Metadata associated with each backtrack step includes details on the clustering paths followed, criteria for linking data items across clusters, and significance of identified relationships. Metadata annotations at the output stage provide insights into final results, including interpretations, confidence levels, and recommendations derived from the analysis. This structured metadata serves as supplemental data accompanying the entity-specific data analysis output, facilitating easier interpretation, validation, and comparison across different analyses or iterations. The structured presentation of clusters and associated metadata enables stakeholders to navigate through the data analysis process effectively, understanding how relevant data items were identified and validated through iterative clustering approaches.

With reference to FIG. 2, FIG. 2 illustrates an example flow diagram 200 for providing entity-specific data analysis. FIG. 2 includes bidirectional volumetric analysis engine 202, data analysis funnel engine 204, and feedback loop engine 206. An entity of interest 210 associated with entity profile data 212 (e.g., internal sales, customer profile, tenancy, and web domain data) and a dataset 214 of the entity (e.g., email associated with a breach) are communicated to the bidirectional volumetric analysis engine 202.

At step 202A, a data instance of the dataset is identified based on one or more data features associated with the entity profile data. For example, a data instance can include emails that are selected based on a second entity domain associated with the entity of interest.

At step 202B, pairs of communication channels are identified. For example, a person-to-person communication channel can be associated with a first person at the entity and a second person at the second entity.

At block 202C, a bidirectional volumetric analysis output based on a volume and balance of communication between pairs is generated. For example, a ranking of directional volume of each pair is generated and one-way communications are filtered out.

A focus area 220 (e.g., focus area identifier) and focus area data (e.g., domain specific data sources-Wikipedia, CVE, MITRE) associated with an investigation of the dataset 214 are provided.

At step 224, the focus area 220 and focus area data 222 are used to generate probe questions that are relevant to the focus area 220. A probe question is a specific type of question designed to cause a probing step LM to generate a response that indicates a presence or absence of certain types of information in data items.

At step 226, the focus area 220 and the focus area data 222 are used to generate analysis axes that are relevant the focus area 220. A data analysis axis is a factor designed to cause a data analysis axes step LM to generate a response that indicates a score and reasoning for certain types of information in data items.

At step 204A, probe questions are run over the bidirectional volumetric analysis output. For example, the probe questions are run over two-way communication emails.

At step 204B, a data analysis-axes prompt is run over data items in the bidirectional volumetric analysis output with positive probes (i.e., probe questions step output).

At step 204C, data analysis axes step output is evaluated for noise patterns in part based on an extraction prompt. For example, a subset of riskiest emails from the analysis axis step output can be used to identify false positive or noise patterns (and false positives).

At step 204D, based on the evaluation, an LM prompt is executed to remove data items with noise patterns.

At step 204E, feedback on a random sample of data items is received. The feedback loop engine 206 operates to execute steps 204C, 204D and 204E, to further refine the entity-specific data analysis output.

At step 204F, entity-specific data analysis output is communicated. For example, entity-specific data analysis output for triage and remediation operations. In this way, generating the entity-specific data analysis output for the entity is further based on: using a probing step LM, generating a probing step output that indicates a presence or absence of certain types of information in data items; using a data analysis axes step LM and the probing step output, generating a data analysis output indicates a score and reasoning for certain types of information in data items.; using an extraction step LM, evaluating a data analysis axes step output to identify a noise pattern in data items; and using a removal step LM, removing data items in the data analysis axes step output with the noise pattern.

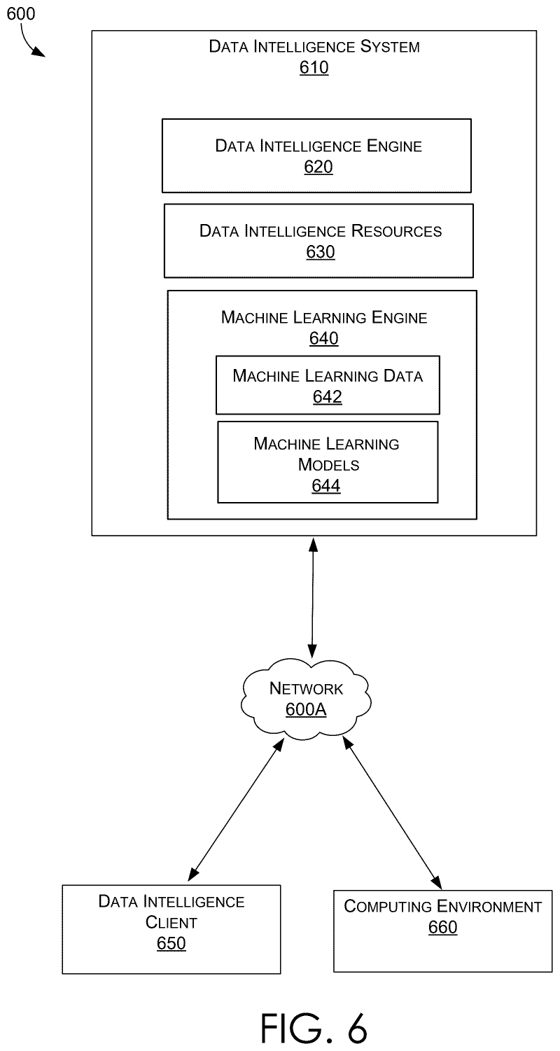

Aspects of the technical solution have been described by way of examples and with reference to FIGS. 1 and FIG. 2. FIG. 1 is a block diagram of an exemplary technical solution environment, based on example environments described with reference to FIGS. 6, 7 and 8 for use in implementing embodiments of the technical solution are shown. Generally the technical solution environment includes a technical solution system suitable for providing the example cloud computing system 100 in which methods of the present disclosure may be employed. In particular, FIG. 1 illustrates a high level architecture of the cloud computing system 100 in accordance with implementations of the present disclosure, among other engines, managers, generators, selectors, or components not shown (collectively referred to herein as “components”).

### Example Methods

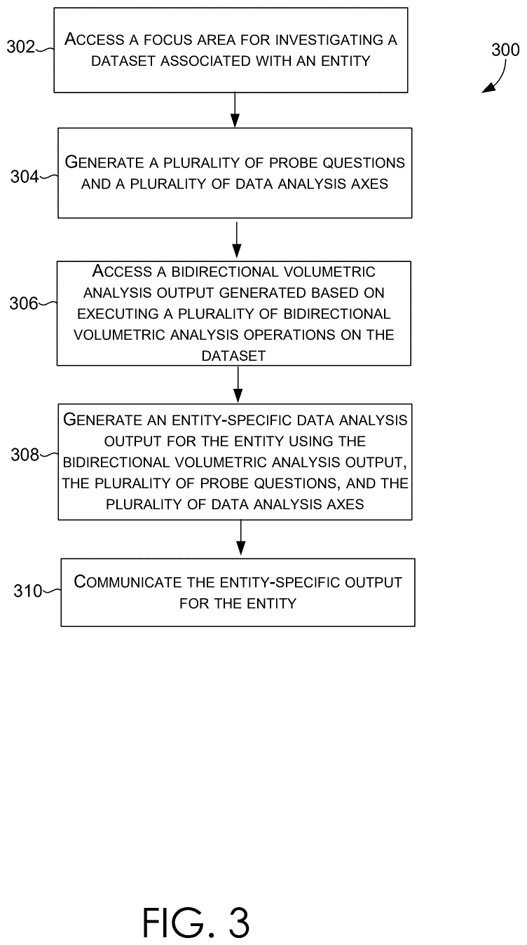

With reference to FIGS. 3, 4, and 5, flow diagrams are provided illustrating methods for providing entity-specific data analysis using an entity-specific data analysis engine in a data intelligence system. The methods may be performed using the design system described herein. In embodiments, one or more computer-storage media having computer-executable or computer-useable instructions embodied thereon that, when executed, by one or more processors can cause the one or more processors to perform the methods (e.g., computer-implemented method) in the data intelligence system (e.g., a computerized system).

Turning to FIG. 3, a flow diagram is provided that illustrates a method 300 for providing entity-specific data analysis using an entity-specific data analysis engine in a data intelligence system. At block 302, generate a plurality of probe questions and a plurality of data analysis axes using the focus area and focus area data. At block 306, access bidirectional volumetric analysis output generated based on executing a plurality of bidirectional volumetric analysis operations on the dataset. At block 308, generate an entity-specific data analysis output for the entity using the bidirectional volumetric analysis output, the plurality of probe questions, and the plurality of data analysis axes. At block 310, communicate the entity-specific output for the entity.

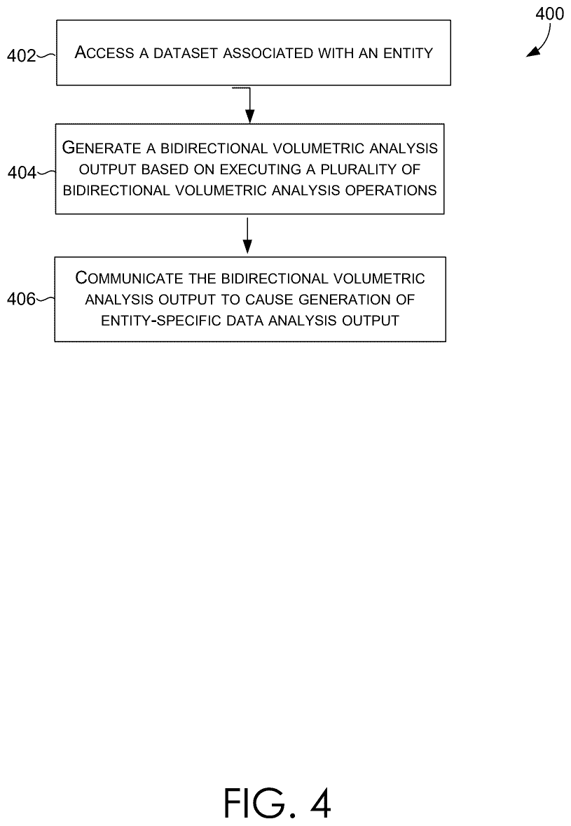

Turning to FIG. 4, a flow diagram is provided that illustrates a method 400 for providing entity-specific data analysis using an entity-specific data analysis engine in a data intelligence system. At block 402, access a dataset associated with an entity. At block 404, generate a bidirectional volumetric analysis output based on executing a plurality of bidirectional volumetric analysis operations. At block 406, communicate the bidirectional volumetric analysis output to cause generation of entity-specific data analysis output.

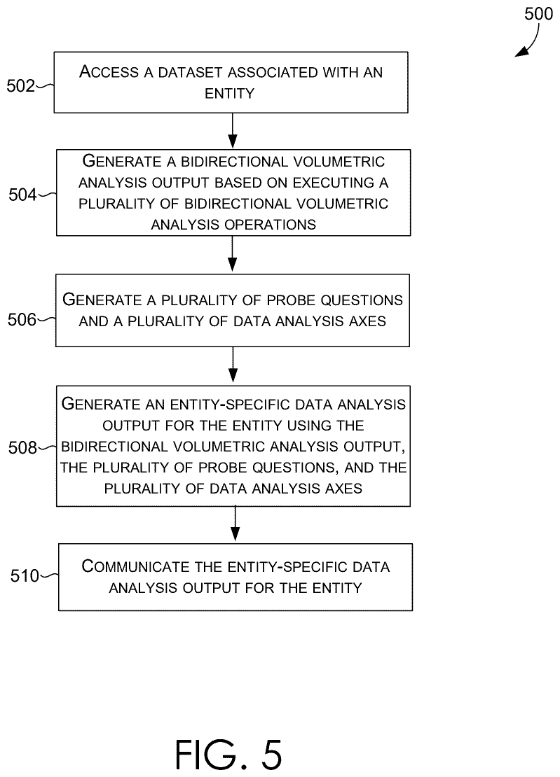

Turning to FIG. 5, a flow diagram is provided that illustrates a method 500 for providing entity-specific data analysis using an entity-specific data analysis engine in a data intelligence system. At block 502, access a dataset associated with an entity. At block 504, generate a bidirectional volumetric analysis output based on executing a plurality of bidirectional volumetric analysis operations. At block 506, generate a plurality of probe questions and a plurality of data analysis axes using a focus area and focus area data. At block 508, generate an entity-specific data analysis output for the entity using the bidirectional volumetric analysis output, the plurality of probe questions, and the plurality of data analysis axes. At block 510, communicate the entity-specific output for the entity.

### Technical Improvement

Embodiments of the present techniques have been described with reference to several inventive features (e.g., operations, systems, engines, and components) associated with a design system. Inventive features described include: operations, interfaces, data structures, and arrangements of computing resources associated with providing the functionality described herein relative with reference to an entity-specific data analysis engine. Functionality of the embodiments of the present invention have further been described, by way of an implementation and anecdotal examples-to demonstrate that the operations for providing the entity-specific data analysis engine as a solution to a specific problem in data intelligence technology to improve computing operations in data intelligence systems.

Advantageously, entity-specific data analysis engine enables emulating and enhancing complex data analysis (e.g., risk analysis) task traditionally carried out by human specialists. In particular, entity-specific bidirectional volumetric analysis enables detecting relevant interactive entity communication, distinguishing the relevant interactive communications from non-interactive content like newsletter, SPAM, or one-way announcements. Few-shot prompting for domain-specific probing can be a key differentiator in that it utilizes few-shot prompts that transform domain knowledge about a company into bespoke probing questions and data analysis axes (e.g., risk axes). This reduces implicit bias and provides a customized analysis for each entity. Iterative filtering and processing pipeline can include filters and processes associated with the data analysis and probing questions to determine which communications are relevant and significant, ensuring entity-specific data features are captured while filtering out noise. Output-triage can be facilitated by few-shot prompts that are utilized to convert probing questions and data analysis axes into output facilitating the entity-specific data analysis approach to data analysis (e.g., risk assessment and management). As such, the entity-specific data analysis engine for entity-specific data analysis offers a strategic advantage by providing a customizable, efficient, and semi-automated solution for managing specific data features of an organization. The entity-specific data analysis engine represent a significant evolutions in data analysis technology, establishing a new paradigm for adaptive, data-driven analysis.

### Additional Support for Detailed Description

### Example Data Intelligence System in a Cloud Computing Environment

Referring now to FIG. 6, FIG. 6 illustrates a computing environment in which implementations of the present disclosure may be employed. In particular, FIG. 6 shows a high level architecture of an example cloud computing platform 600 and data intelligence system 610 that can host a technical solution environment. It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

The cloud computing environment 100 provides computing system resources for different types of managed computing environments. For example, the cloud computing platform supports delivery of computing services—including compute, servers, storage, databases, networking, and intelligence. The components of cloud computing environment 600 may communicate with each other over a network 600A which may include, without limitation, one or more local area networks (LANs) and/or wide area networks (WANs).

The data intelligence system 610 provides data intelligence functionality for computing environments. The data intelligence system 610 is a platform or framework that leverages advanced technologies such as artificial intelligence (AI), machine learning (ML), data mining, and big data analytics to extract actionable insights and knowledge from large and complex datasets. In this way, the data intelligence system 610 provides a computing environment that enables organizations to make informed decisions and optimize operations.

The data intelligence system 610 can be implemented as a security management system that supports planning, implementing, controlling, and monitoring security measures to protect assets, resources, and information from various threats and risks in computing environment. Data intelligence system 610 as a security management system is configured to trigger alerts for potential or actual threats—including suspicious behavior or malicious behavior-in a computing environment. For example, an alert configuration can be defined to include alert settings, which if met, trigger an alert. The security alert can refer to a human-readable, technical notification regarding current vulnerabilities, exploits, and other security issues associated with a computing environment. The alert can be communicated to a client device that is managed by a security administrator who can then follow up on the alert. The security management system can be a security management system described in U.S. patent application Ser. No. 18/451,405, filed Aug. 17, 2023, entitled “ARTIFICIAL INTELLIGENCE ENGINE IN A SECURITY MANAGEMENT SYSTEM,” which is incorporated herein by reference in its entirety.

The data intelligence system 610 can further support generating security posture visualizations based on security management engine output. The security posture information can be generated security management engine output such that security posture information is prioritized and filtered. A prioritization identifier (e.g., high, medium, low) can be provided in the security posture visualization in combination with an alert associated with a security incident. Alternatively, a notification associated with the security management information, security prioritization information or the alert can be communicated. Other variations and combinations of communications associated with security management engine output are contemplated with embodiments described herein.

The data intelligence system 610 includes a data intelligence engine 620 that is a computing environment that supports executing computational tasks associated with the data intelligence system 610. The data intelligence engine 620 can be a hardware or software component that performs computational operations, such as, mathematical calculations, data processing, and algorithm execution. The data intelligence system 610 integrates data intelligence resources 630 into data intelligence system 610 to effectively provide data intelligence functionality in a computing environment.

The data intelligence engine 620 may collect, aggregate, and integrate data from diverse sources, including structured and unstructured data, internal and external data sources, streaming data, and historical data repositories. The data intelligence engine 620 may further applying a variety of analytical techniques and algorithms, they automate the process of extracting insights, employing machine learning algorithms, AI techniques, and predictive analytics to discover patterns, classify data, make predictions, and generate recommendations.

The data intelligence engine 620 provides visualization tools and dashboards to enable users to explore data, identify trends, and communicate insights effectively, while robust data governance policies and security measures ensure that data is managed and accessed securely, compliantly, and ethically. The data intelligence system 610 is designed for scalability and performance, in this way the data intelligence system 610 can handle large volumes of data and support high-performance analytics, including real-time and streaming analytics capabilities for faster decision-making and proactive interventions.

The data intelligence resources 630 refer to computing elements (e.g., components, capability, or entities) that collectively enable the data intelligence engine 620 operations. The data intelligence resources 630 encompass a spectrum of computing elements, beginning with the diverse operations the data intelligence resources 630 can perform, ranging from complex computations to data manipulations. Interfaces, an integral part of the data intelligence resources 630, provide the means for both user interaction and seamless integration with external systems, ensuring a dynamic and interactive computing experience. The data facet of the data intelligence resources 630 involves various types: input data, which is the information provided for processing; processing data, representing the data manipulated during computational tasks; and output data, the results generated by the data intelligence engine 620. In this way, the data intelligence resources 630 support the broader data intelligence engine 620 and data intelligence system 610.

Data intelligence resources 630 include operations, interfaces, and data that support providing data intelligence functionality—operations encompass the tasks performed on the data, interfaces facilitate interaction with the data intelligence system 610, and data serves as the input and output of the system's operations, forming the core components of a data intelligence system. In particular, operations in a data intelligence system 610 encompass tasks such as data acquisition, preprocessing, analysis, model training, inference, visualization, and reporting. Operations involve manipulating data to extract insights and intelligence. For instance, preprocessing may involve cleaning and transforming data, while analysis could include descriptive statistics or predictive modeling. Interfaces serve as points of interaction between users, applications, and the system, facilitating access to functionality and consumption of outputs. Examples include graphical user interfaces (GUIs), command-line interfaces (CLIs), and application programming interfaces (APIs), and data visualization tools, which allow users to interact with and visualize results. Data, comprising raw and processed information, serves as the input and output of system operations. Data may originate from various sources, structured or unstructured, and undergo preprocessing before analysis. Examples include customer data, financial data, and sensor data stored in formats like databases or data lakes.

Machine learning engine 640 is a machine learning framework or library that operates as a tool for providing infrastructure, algorithms, capabilities for designing, training, and deploying machine learning models. The machine learning engine 640 can include pre-built functions and APIs that enable building and applying machine learning techniques. The machine learning engine 140 can provide a machine learning workflow from data processing and feature extraction to model training, evaluation, and deployment.

Machine learning data 642 refers to the structured or unstructured information used to train, validate, and test machine learning models. This machine learning data 642 typically comprises input features (also known as independent variables or predictors) and their corresponding target values (also known as dependent variables or labels). Machine learning data 642 can come from various sources, such as databases, sensor readings, text documents, images, audio recordings, or streaming data sources. Machine learning data 642 may require preprocessing, cleaning, and transformation to ensure its suitability for training machine learning models. Additionally, machine learning data 642 is often divided into training, validation, and testing sets to assess the performance and generalization ability of trained models accurately.

Machine learning models 644 are algorithms or mathematical representations that learn patterns and relationships from the provided data to make predictions or decisions without being explicitly programmed. Machine learning models 644 models are trained using the machine learning data 642, where they iteratively adjust their internal parameters or coefficients to minimize prediction errors or maximize performance metrics. Machine learning models 644 can be classified into various types based on their learning algorithms and the nature of the problem they address, including supervised learning models (e.g., regression, classification), unsupervised learning models (e.g., clustering, dimensionality reduction), and reinforcement learning models. Once trained, machine learning models 644 can be deployed in production environments to make predictions on new, unseen data instances. Regular evaluation and monitoring of model performance are essential to ensure their accuracy, reliability, and effectiveness in real-world applications.

The data intelligence client 650 supports access to data intelligence system 610 660. The data intelligence client 650 can be provided as a user client or an administrator client to support user and administrator functionality associated with the computing environment 660, data intelligence engine 620, or data intelligence system 610. The data intelligence client 650 can also support accessing data intelligence visualizations and causing display of the data intelligence visualization. The data intelligence client 650 can include a data intelligence engine client that supports receiving data intelligence information associated data intelligence engine 620 output from the data intelligence system 610 and causing presentation of the data intelligence information. The data intelligence information can specifically include data intelligence visualizations associated with the data intelligence engine 620 output.

Data intelligence client 650 provides a graphical or command-line interface for users or administrators to interact with data intelligence system 610. The data intelligence client 650 serves as the interface between users or systems and the underlying data intelligence system, facilitating interactions, querying data, retrieving results, and visualizing insights derived from analyzed data. Users can configure and customize system behavior, adjust parameters, and define workflows through the client interface, tailoring the system to specific use cases or requirements. Interactive visualization tools, including charts, graphs, maps, and dashboards, enable users to explore and interpret data intuitively. Some clients offer built-in tools for data analysis, statistical modeling, and machine learning, allowing users to uncover patterns and trends within the data. Collaboration features support sharing insights, collaborating on analyses, and communicating findings with colleagues or stakeholders. Security measures such as user authentication, access control, encryption, and audit logging ensure data protection and compliance with security policies and regulations.

The data intelligence client 650 can further support executing a remediation action. In particular, the security posture visualization can include a remediation action for an alert associated with data intelligence engine 620 output. The data intelligence client 650 can receive an indication to perform the remediation action associated with data intelligence engine 620 output. Based on receiving the indication to execute the remediation action, the data intelligence client 650 can communicate the indication to execute the remediation action to cause execution of the remediation action.

Computing environment 660 is a computing environment that is integrated into the data intelligence system 610. The computing environment 660 is characterized by an infrastructure, where data from various sources within the ecosystem, including servers, networks, applications, sensors, and user interactions, can be aggregated and processed by the data intelligence system 610 to derive actionable insights. The computing environment 660 can be associated with middleware and integration layers facilitate seamless data flow, while computing infrastructure, encompassing cloud-based resources, distributed computing frameworks, and optimized storage systems, supports functionality associated with the data intelligence.

### Example Distributed Computing System Environment

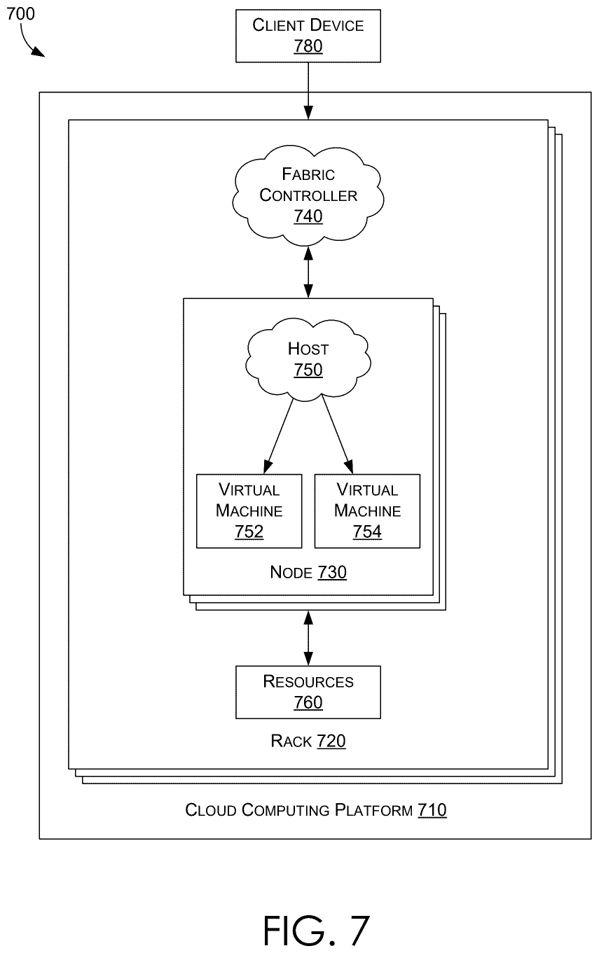

Referring now to FIG. 7, FIG. 7 illustrates an example distributed computing environment 700 in which implementations of the present disclosure may be employed. In particular, FIG. 7 shows a high level architecture of an example cloud computing platform 710 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 700 that includes cloud computing platform 710, rack 720, and node 730 (e.g., computing devices, processing units, or blades) in rack 720. The technical solution environment can be implemented with cloud computing platform 710 that runs cloud services across different data centers and geographic regions. Cloud computing platform 710 can implement fabric controller 740 component for provisioning and managing resource allocation, deployment, upgrade, and management of cloud services. Typically, cloud computing platform 710 acts to store data or run service applications in a distributed manner. Cloud computing infrastructure 710 in a data center can be configured to host and support operation of endpoints of a particular service application. Cloud computing infrastructure 710 may be a public cloud, a private cloud, or a dedicated cloud.

Node 730 can be provisioned with host 750 (e.g., operating system or runtime environment) running a defined software stack on node 730. Node 730 can also be configured to perform specialized functionality (e.g., compute nodes or storage nodes) within cloud computing platform 710. Node 730 is allocated to run one or more portions of a service application of a tenant. A tenant can refer to a customer utilizing resources of cloud computing platform 710. Service application components of cloud computing platform 710 that support a particular tenant can be referred to as a multi-tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 730, nodes 730 may be partitioned into virtual machines (e.g., virtual machine 752 and virtual machine 754). Physical machines can also concurrently run separate service applications. The virtual machines or physical machines can be configured as individualized computing environments that are supported by resources 760 (e.g., hardware resources and software resources) in cloud computing platform 710. It is contemplated that resources can be configured for specific service applications. Further, each service application may be divided into functional portions such that each functional portion is able to run on a separate virtual machine. In cloud computing platform 710, multiple servers may be used to run service applications and perform data storage operations in a cluster. In particular, the servers may perform data operations independently but exposed as a single device referred to as a cluster. Each server in the cluster can be implemented as a node.

Client device 780 may be linked to a service application in cloud computing platform 710. Client device 780 may be any type of computing device, which may correspond to computing device 700 described with reference to FIG. 7, for example, client device 780 can be configured to issue commands to cloud computing platform 710. In embodiments, client device 780 may communicate with service applications through a virtual Internet Protocol (IP) and load balancer or other means that direct communication requests to designated endpoints in cloud computing platform 710. The components of cloud computing platform 710 may communicate with each other over a network (not shown), which may include, without limitation, one or more local area networks (LANs) and/or wide area networks (WANs).

### Example Computing Environment

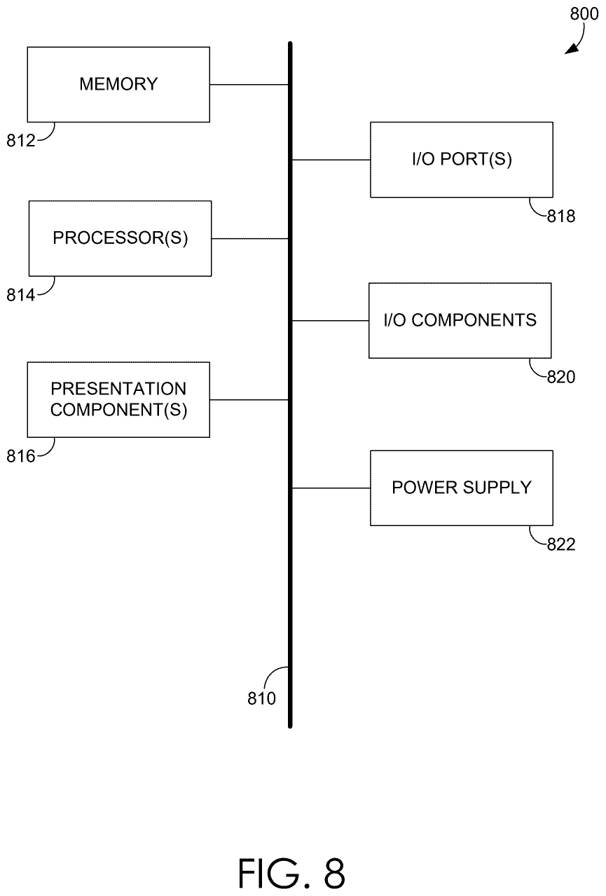

Having briefly described an overview of embodiments of the present technical solution, an example operating environment in which embodiments of the present technical solution may be implemented is described below in order to provide a general context for various aspects of the present technical solution. Referring initially to FIG. 8 in particular, an example operating environment for implementing embodiments of the present technical solution is shown and designated generally as computing device 800. Computing device 800 is but one example of a suitable computing environment and is not intended to suggest any limitation as to the scope of use or functionality of the technical solution. Neither should computing device 800 be interpreted as having any dependency or requirement relating to any one or combination of components illustrated.

The technical solution may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The technical solution may be practiced in a variety of system configurations, including hand-held devices, consumer electronics, general-purpose computers, more specialty computing devices, etc. The technical solution may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output ports 818, input/output components 820, and illustrative power supply 822. Bus 810 represents what may be one or more buses (such as an address bus, data bus, or combination thereof). The various blocks of FIG. 8 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 8 is merely illustrative of an example computing device that can be used in connection with one or more embodiments of the present technical solution. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc.

### Additional Structural and Functional Features

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technical solution is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technical solution are described with reference to a distributed computing environment; however, the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present technical solution may generally refer to the technical solution environment and the schematics described herein, it is understood that the techniques described may be extended to other implementation contexts.

For purposes of this disclosure the word “support” refers to provisioning of functionality, services, or assistance by a computing component or through computing operations within a broader computing system. When a computing component or set of operations supports a specific functionality, it means that it plays a role in enabling or executing that particular aspect of the computing system. This support can manifest in various ways, including the processing of data, execution of operations, management of resources, and ensuring compatibility or interoperability with other components. Additionally, support may involve providing interfaces, APIs (Application Programming Interfaces), or protocols that allow seamless interaction and integration with other elements of the computing system. The concept of support extends beyond mere functionality provision to encompass maintenance, troubleshooting, and the overall optimization of computing resources to ensure the robust and efficient operation of the computing system.

Embodiments of the present technical solution have been described in relation to particular embodiments which are intended in all respects to be illustrative rather than restrictive. Alternative embodiments will become apparent to those of ordinary skill in the art to which the present technical solution pertains without departing from its scope.

From the foregoing, it will be seen that this technical solution is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors; and
computer memory storing computer-useable instructions that, when used by the one or more computer processors, cause the one or more computer processors to perform operations, the operations comprising:
accessing a focus area for investigating a dataset associated with an entity;
using the focus area and focus area data, generating a plurality of probe questions and a plurality of data analysis axes;
accessing bidirectional volumetric analysis output generated based on executing a plurality of bidirectional volumetric operations on the dataset, wherein the plurality of bidirectional volumetric analysis operations enable selecting data items associated with communications involving back-and-forth interactions between sender-recipient pairs, while simultaneously excluding data items associated with one-way communications that lack reciprocal exchanges between sender-recipient pairs;
using the bidirectional volumetric analysis output, the plurality of probe questions, and the plurality of data analysis axes, generating an entity-specific data analysis output for the entity, wherein the entity-specific data analysis output is generated using a data analysis funnel comprising a probing step Language Model (LM) that operates based on the plurality of probe questions and a data analysis axes step LM that operates based on the plurality of data analysis; and
communicating the entity-specific output for the entity.

2. The system of claim 1, wherein the entity-specific output is generated using an entity-specific data analysis engine that supports customizable multi-view iterative processing based on a bidirectional volumetric analysis engine and data analysis funnel engine associated with corresponding computational costs.

3. The system of claim 1, wherein the dataset is associated data items having a data feature that is a sender-recipient pair identifier associated with determining two-way communications between the entity and a second entity.

4. The system of claim 1, wherein a probe question is a specific type of question designed to cause the probing step LM to generate a response that indicates a presence or absence of certain types of information in data items.

5. The system of claim 1, wherein a data analysis axis is a factor designed to cause the data analysis axes step LM to generate a response that indicates a score and reasoning for certain types of information in data items.

6. The system of claim 1, wherein generating the entity-specific data analysis output for the entity is further based on:
using the probing step LM generating a probing step output that indicates a presence or absence of certain types of information in data items;
using the data analysis axes LM and the probing step output, generating a data analysis output indicates a score and reasoning for certain types of information in data items;
using an extraction step LM, evaluating a data analysis axes step output to identify a noise pattern in data items; and
using a removal step LM, removing data items in the data analysis axes step output with the noise pattern.

7. The system of claim 1, further comprising a feedback loop engine associated with iteratively executing an extraction step LM and a removal step LM based on feedback on a sample of data items.

8. A method, the method comprising:
accessing a dataset associated with an entity, wherein the dataset comprises a plurality of data items;
generating a bidirectional volumetric analysis output based on executing a plurality of bidirectional volumetric analysis operations, wherein the plurality of bidirectional volumetric analysis operations enable selecting data items associated with communications involving back-and-forth interactions between sender-recipient pairs, while simultaneously excluding data items associated with one-way communications that lack reciprocal exchanges between sender-recipient pairs;
generating a plurality of probe questions and a plurality of data analysis axes using a focus area and focus area data; and
using the bidirectional volumetric analysis output, the plurality of probe questions, and the plurality of data analysis axes, generating an entity-specific data analysis output for the entity, wherein the entity-specific data analysis output is generated using a data analysis funnel comprising a probing step Language Model (LM) that operates based on the plurality of probe questions and a data analysis axes step LM that operates based on the plurality of data analysis.

9. The method of claim 8, wherein the entity-specific output is generated using an entity-specific data analysis engine that supports customizable multi-view iterative processing based on a bidirectional volumetric analysis engine and data analysis funnel engine associated with corresponding computational costs.

10. The method of claim 8, wherein the plurality of data items are associated with a data feature that is a sender-recipient pair identifier that supports determining two-way communications between the entity and a second entity.

11. The method of claim 8, wherein the plurality of bidirectional volumetric analysis operations include each of the following:
an initial filtering operation associated with identifying a data instance;
a pre-processing operation associated with identifying sender-recipient pairs that define corresponding communication channels;
a metrics calculation operation associated with quantifying a volume of communications and a balance of communications between sender-recipient pairs; and
a ranking operation associated employing volume metrics or balance metrics to rank data items associated with sender-recipient pairs.

12. The method of claim 8, wherein a probe question is a specific type of question designed to cause the probing step LM to generate a response that indicates a presence or absence of certain types of information in data items.

13. The method of claim 8, wherein a data analysis axis is a factor designed to cause the data analysis axes step LM to generate a response that indicates a score and reasoning for certain types of information in data items.

14. The method of claim 8, wherein generating the entity-specific data analysis output for the entity is further based on:
using the probing step LM generating a probing step output that indicates a presence or absence of certain types of information in data items;
using the data analysis axes LM and the probing step output, generating a data analysis output indicates a score and reasoning for certain types of information in data items;
using an extraction step LM, evaluating a data analysis axes step output to identify a noise pattern in data items; and
using a removal step LM, removing data items in the data analysis axes step output with the noise pattern.

15. One or more computer-storage media having computer-executable instructions embodied thereon that, when executed by a computing system having a processor and memory, cause the processor to perform operations, the operations comprising:
accessing a dataset associated with an entity, wherein the dataset comprises a plurality of data items;
generating a bidirectional volumetric output based on executing a plurality of bidirectional volumetric analysis operations, wherein the plurality of bidirectional volumetric analysis operations enable selecting data items associated with communications involving back-and-forth interactions between sender-recipient pairs, while simultaneously excluding data items associated with one-way communications that lack reciprocal exchanges between sender-recipient pairs; and
communicating the bidirectional volumetric analysis output to cause generation of entity-specific data analysis output, wherein the entity-specific data analysis output is generated using a data analysis funnel comprising a probing step Language Model (LM) that operates based on the plurality of probe questions and a data analysis axes LM that operates based on the plurality of data analysis.

16. The media of claim 15, wherein the entity-specific output is generated using an entity-specific data analysis engine that supports customizable multi-view iterative processing based on a bidirectional volumetric analysis engine and data analysis funnel engine associated with corresponding computational costs.

17. The media of claim 15, wherein a first bidirectional volumetric analysis operation is an initial filtering operation associated with identifying a data instance, wherein the data instance is a subset of data items in the dataset, wherein the data instance is generated based on one or more data features associated with entity profile data of the entity.

18. The media of claim 15, wherein a second bidirectional volumetric analysis operation is a pre-processing operation associated with identifying sender-recipient pairs that define corresponding communication channels.

19. The media of claim 15, wherein a third bidirectional volumetric analysis operation is a metrics calculation operation associated with quantifying a volume of communications and a balance of communications between sender-recipient pairs.

20. The media of claim 15, wherein a fourth bidirectional volumetric analysis operation is a ranking operation associated with employing volume metrics or balance metrics to rank data items associated with sender-recipient pairs.
